(19) United States
(12) Patent Application Publication
(10) Pub. No.: US 2011/0100820 A1
(43) Pub. Date: May 5, 2011

(54) TRIPLE FUNCTION ELECTRODES

(75) Inventors: Till Bachmann, Edinburgh (GB); Andrew Mount, Edinburgh (GB); Anthony Walton, Edinburgh (GB)

(73) Assignee: ITI SCOTLAND LIMITED, Glasgow (GB)

(21) Appl. No.: 12/994,424

(22) PCT Filed: Mar. 20, 2009
(86) PCT No.: PCT/EP2009/053325

§ 371 Date: Jan. 18, 2011

(30) Foreign Application Priority Data
May 23, 2008 (GB) 0809486.4
Mar. 11, 2009 (EP) PCT/EP2009/052884

(51) Int. Cl. G01N 27/447

(52) U.S. Cl. 204/547; 204/643

(57) ABSTRACT

Provided is a device for assaying one or more analytes, said device comprising an electrode, a means for optical detection; and a means for electrochemical detection, wherein the device is configured such that the electrode is capable of promoting transport of an analyte when a field is applied to the analyte via the electrode, and wherein the means for electrochemical detection employs the electrode and the means for optical detection employs the electrode, and wherein the device is configured to carry out dielectrophoresis.

Further provided is the use of the device of the present invention for promoting transport of an analyte, detecting the optical properties of the analyte and detecting the electrochemical properties of the analyte.

Also provided is method for assaying one or more analytes, which method comprises the steps of: promoting transport of an analyte, performing an optical measurement of the analyte and performing an electrochemical measurement of the analyte, which method employs the device of the present invention.

### FIELD OF INVENTION

The present invention relates to a device for assaying one or more analytes in a sample, said device comprising an electrode, means for optical detection and means for electrochemical detection, wherein the device is configured such that the analyte is capable of attachment to the electrode, for example via a capture probe that is a component of the electrode.

### BACKGROUND OF THE INVENTION

Indium tin oxide (ITO) thin films have been widely used as transparent electrodes in applications including solar cells, gas sensors and flat panel displays, due to the material's excellent optical transparency and electrical conductivity. Deposition of these films is typically carried out by evaporation and DC magnetron sputtering.

Conventional wet etching solutions used for ITO films are typically composed of strong acids including halogen acids, such as hydrochloric acid (Huang, C. J., Su, Y. K., & Wu, S. L. The effect of solvent on the etching of ITO electrode. Materials Chemistry and Physics 84, 146-150 (2004)).

Dry etching methods have also been investigated for patterning of ITO thin films (Mohri, M., Kakinuma, H., Sakamoto, M., & Sawai, H. Plasma-Etching of Ito Thin-Films Using A Ch4/H2 Gasixture. Japanese Journal of Applied Physics Part 2-Letters 29, LI 932-L1935 (1990)).

Electrodes to improve target binding (“forced transport”) have been described in the following documents:
Tashiro, Hideo; WO2004111644, WO2005083448) Dielectrophoresis
Lida, Tomoko; Segawa, Yuji; Onishi, Michihiro; Mamine, Takayoshi. Dielectrophoretic facilitation of DNA hybridization process for efficient and accurate detection of base-mismatching mutation. Jpn. Kokai Tokkyo Koho (2005), 12 pp. CODEN: JKXXAF JP 2005345365 A 20051215 CAN 144:32831 AN 2005:1305817.
Higasa, Masashi; Nagino, Kunihisa. Method and apparatus for hybridization of selective binding substance, and selective binding substance-disposed base material. Jpn. Kokai Tokkyo Koho (2003), 15 pp. CODEN: JKXXAF JP 2003202343 A 20030718 CAN 139:81602 AN 2003: 550509.
Sudo, Yukio. Hybridization method and apparatus using alternative elec. field. Jpn. Kokai Tokkyo Koho (2003), 24 pp. CODEN: JKXXAF JP 2003177128 A 20030627 CAN 139:32874 AN 2003:488754.

Large fragment DNA (Plasmid) collection on interdigitated electrodes by AC field induced dielectrophoresis has been described in Bakewell D J, Morgan H. Dielectrophoresis of DNA: time- and frequency-dependent collections on microelectrodes. IEEE Trans Nanobioscience. 2006 March; 5(1):I-8.

Interdigitated Electrodes for electrochemical detection have also been described in the literature (Daniels, J. S., Pourmanda, N., “Label-Free Impedance Biosensors: Opportunities and Challenges”, Electroanalysis, 19, 2007, 1239-1257.)

Siemens AG also focused on electrochemical impedance spectroscopy based on interdigitated electrodes in WO2004057022.

Combined systems have also been described in WO9906835A1 and Asanov, A. N., Wilson, W. W., & Odham, P. 33. Regenerable biosensor platform: A total internal reflection fluorescence cell with electrochemical control. Analytical Chemistry 70, 1156-1163 (1998). A biosensor platform that provides simultaneous fluorescence detection and electrochemical control of biospecific binding has been developed and investigated using antibody-antigen and streptavidin-biotin interactions. The TIRF cell was used in conjunction with an SLM-Aminco AB-2 fluorescence spectrophotometer. For the TIRF electrochemistry (TIRF-EC) experiments, the TIRF flow cell was combined with a three-electrode system. Slab optical waveguide spectroscopy is a technique to optically study electron transfer reactions on electrode surfaces.

However, no electrodes, or devices containing them, which are able to carry out the three functions of promoting transport of analytes in a sample, detecting their optical properties and detecting their electrochemical properties have been previously described. A problem with the prior art therefore is that separate devices are required in order to carry out all three functions. Not only are the prior art arrangements less convenient but also more expensive and can be more time consuming since separate devices need to be operated to carry out all three functions. Furthermore, since separate devices are required to carry out all these functions and therefore a more bulky arrangement as a whole, no device in a portable form able to carry out all these three functions has previously been described. So far nobody has been able to combine all three functions in a single device.

In addition to the need for improved sensitivity and selectivity in analyte detection devices and methods, there is also therefore a growing need for quick, cheap and simple detection devices and methods with reduced assay time.

It is an object of the present invention to overcome the problems and deficiencies associated with the prior art. In particular, it is an aim of this invention to provide a device and method for detecting an analyte which is efficient, convenient, quick, cheap and simple to use.

### SUMMARY OF THE INVENTION

A first aspect of the present invention is a device for assaying one or more analytes, said device comprising:
(a) an electrode;
(b) a means for optical detection; and
(c) a means for electrochemical detection;
   wherein the device is configured such that the electrode is capable of promoting transport of an analyte when a field is applied to the analyte via the electrode; and wherein the means for electrochemical detection employs the electrode; and the means for optical detection employs the electrode, and wherein the device is configured to carry out dielectrophoresis.

Another aspect of the present invention is the use of the device of the present invention for promoting transport of an analyte, detecting the optical properties of the analyte and detecting the electrochemical properties of the analyte.

A further aspect of the present invention is a method for assaying one or more analytes, which method comprises the steps of:
a) promoting transport of an analyte
b) performing optical measurement of the analyte
c) performing an electrochemical measurement of the analyte;
   wherein said method employs the device of the present invention.

The present invention comprises the use of electrodes for electrochemical detection, optical detection, and accelerated binding in biomolecular interaction assays (e.g. DNA biosensors). The invention is comprised of an electrode configuration which can perform (1) electrochemical detection (e.g. electrochemical impedance spectroscopy), (2) optical detection (e.g. total internal reflection fluorescence), and (3) forced transport of target molecules (for example by dielectrophoresis) at the same time or sequentially.

The present invention enables highly sensitive and rapid detection of analytes using probe target reactions by an enhanced signal to noise ratio (optical and electrochemical transduction) and enhanced binding rate (forced transport).

A further advantage of the present invention is that it enables very high packing densities on microelectrode chips due to the incorporation of three functions in a single electrode. Higher packing densities lead to higher yields and thus to lower production costs. Furthermore, the reduction of size enables portable triple function detection devices.

### DETAILED DESCRIPTION OF THE INVENTION

In the present invention there is provided a device for assaying one or more analytes, said device comprising: an electrode, means for optical detection and means for electrochemical detection, wherein the device is configured such that the electrode is capable of promoting transport of an analyte when a field is applied to the analyte via the electrode; and wherein the means for electrochemical detection employs the electrode; and the means for optical detection employs the electrode.

Typically the present device may be a fluidic device, such as a microfluidic or nanofluidic device.

The present invention is preferably directed to analytes that are bio-molecules, although any charged ionisable or polarisable analytes may be assayed, if desired. Without being especially limited the analyte may comprise one or more compounds selected from a cell, a protein, a polypeptide, a peptide, a peptide fragment, an amino acid, a carbohydrate, a lipid, a natural or synthetic chemical or metabolite or nucleic acid such as DNA or RNA.

The analyte is usually contained in a sample. The sample typically comprises a biological sample such as a cellular sample. The biological sample may or may not need to be pre-treated, depending on its structure.

In a preferred embodiment the electrode is composed of an optically transparent material. While the material is not especially limited, provided that it does not unduly hinder any of the electrode function, indium tin oxide (ITO) may be employed as the optically transparent material.

In a further preferred embodiment, the device is suitable for promoting transport of an analyte to the electrode (whether or not the analyte is labelled), detecting the optical properties of the analyte and detecting the electrochemical properties of the analyte. The optical detection and electrochemical detection may be carried out either sequentially or simultaneously.

In another preferred embodiment of the present invention the electrode may further comprise a capture probe, which capture probe is capable of reacting with the analyte to capture the analyte on the electrode. Where the electrode comprises the capture probe the position and/or orientation of capture probe may be influenced to promote binding of the analyte to the capture probe. Orientation of the capture probe may also be employed to enhance the means for optical detection and/or the means for electrochemical detection.

The analyte may bind directly to the electrode or the capture probe may react with the analyte to capture it on the electrode. Any capture probe known in the art could be suitable for use depending upon the analyte to be detected. For example, a DNA probe may be used to capture a specific DNA target sequence by hybridisation. This embodiment is particularly suitable when the analyte is DNA wherein the DNA is collected at the region of high electric fields at the electrodes.

The device according to the present invention is preferably configured to carry out an assay method for detecting the presence or absence of the analyte in the sample. In this embodiment, the assay method may also comprise quantifying the sample.

Techniques to purify, isolate, sort and quantify analyte in a sample are well known by the person skilled in the art and accordingly the device and method according to the present invention can be easily adapted for carrying out the specific processing of the analyte required.

In the embodiment where there is a plurality of electrodes, the analyte and/or the capture probe may be influenced to binding to the electrodes and/or between the electrodes.

Without being especially limited the plurality of electrodes are preferably in the form of an interdigitated electrode structure.

### Forced Transport

In a preferred embodiment the device is configured to carry out dielectrophoresis. The device and method according to the present invention are particularly advantageous for assaying analytes which have electrical properties which allow them to exhibit a strong dielectrophoretic activity in the presence of an electric field. Accordingly, analytes which exhibit effective polarizability in an electric field are particularly suited to the present invention. In this regard, the device and assay method are particularly useful for detecting DNA or RNA which can be easily manipulated using electric fields.

In a preferred embodiment the device is configured to apply at least two alternating fields, wherein at least one alternating field is composed of a plurality of pulses to influence a sample and/or the electrode or capture probe capable of binding an analyte.

The wording “alternating field” means that an electric field which has a non-constant value which may be created, for example, by applying alternating current (AC) or an alternating voltage to a pair of electrodes. It should be noted here that the term AC can apply to both alternating current and alternating voltage.

The wording “alternating field composed of a plurality of pulses” means more than one application of the alternating field, typically in immediate succession, for example by switching the applied field on and off, or by reducing and then increasing the field (or vice versa). This includes single peak magnitudes along with varying peak magnitudes and varying frequencies for the first field.

The wording “apply a second alternating field” and “apply one or more further alternating fields” means that a second or one or more further alternating fields are applied simultaneously with the first alternating field. For example, the two or more alternating fields may be a series of superimposed fields, each having different frequencies and/or shapes, such as sinusoidal or square. For example, a high frequency sinusoidal alternating field and low frequency sinusoidal alternating field may be superimposed and applied simultaneously. Alternatively, the second or one or more further alternating fields are applied sequentially after the first alternating field.

In a preferred embodiment, the first alternating field controls movement of the analyte towards the electrode and the second alternating field promotes binding of the analyte to the electrode.

The present inventors have surprisingly found that application of a first alternating field and a second alternating field to a medium comprising a sample reduces the time and increases the sensitivity for processing the sample.

The present inventors have also surprisingly found that application of a first alternating field composed of a plurality of pulses and optionally a second alternating field to a medium comprising a sample reduces the time and increases the sensitivity for processing the sample.

Preferably the second alternating field is composed of a plurality of pulses and has a second frequency, a second pulse duration and a second pulse rise time.

In a preferred embodiment, the first alternating field and second alternating field are different. In this embodiment, the first and second alternating field may differ by their frequency and/or pulse duration and/or pulse rise time and/or amplitude.

The inventors have unexpectedly found that more than one alternating field, which may be pulsed and are preferably different, can be used to manipulate an analyte and improve the speed and efficiency of processing a sample. The alternating fields are able to control different events which occur during the method, including bulk events, such as movement of the analyte to the electrode (i.e. toward the detector), and surface confined events, such as binding of the analyte to the electrode. Accordingly, the first alternating field may be used to control movement of the analyte to the electrode, for example movement of DNA to the electrode. The first and/or the second alternating field may be used to control binding of the analyte to the electrode, for example DNA hybridisation. In one embodiment, the first and/or second alternating field may be used to position and/or orientate the capture probes attached to the electrode, for example by elongation, to enhance the hybridization efficiency. The first and/or second alternating field may also be applied after the analyte has bound to the electrode to remove unspecifically bound analyte and any adsorbed analyte and improve the washing efficiency. For example, an alternating field may be applied during washing with a buffer. If the buffer used for washing has a high ionic strength this induces negative dielectrophoresis and unspecifically bound analytes, such as DNA, would be driven to the region from the region of high electric fields near the electrodes to a region of lower electric fields away from electrodes. This is particularly useful because it is easy to remove unspecifically bound analytes and promote their movement away from electrodes.

The present inventors have also found that if the alternating field applied comprises a plurality of pulses the manipulation of an analyte and/or a binding phase is improved and, therefore, the speed and efficiency of processing a sample is improved.

The frequency and amplitude of the alternating fields is set at a suitable level which allows for optimal polarity of the analyte being processed thereby allowing selective manipulation and movement of the target analyte and/or the electrode or capture probe. The specific frequency and amplitude required for each alternating field will depend upon the type of sample being processed, the electrical properties, density, shape and size of the target analyte.

In the embodiment where the alternating field comprises a plurality of pulses, the pulse rise time and frequency of the alternating field are set at a suitable level which allows for optimal movement of the analyte through the medium. The specific pulse rise time and frequency required for each alternating field composed of plurality of pulses will depend upon the type of sample being processed, the electrical properties, the density, shape and size of the target analyte. Without being bound by theory it may be that a large pulse rise time and low frequency may be required for larger analytes to allow sufficient force to be applied for sufficient time to cause them to move.

The first and second alternating fields may be applied either simultaneously or sequentially depending upon the type of events to be controlled in the assay device. In one embodiment both the first and second alternating fields are composed of a plurality of pulses. In the embodiment wherein the first and second alternating fields are applied sequentially the voltage, and/or frequency and/or pulse duration and/or pulse rise time of the first alternating field may be changed in order to produce the second pulsed alternating field. Preferably, the first and second alternating field are applied simultaneously.

In the embodiment where the alternating field(s) is/are composed of a plurality of pulses, the number of pulses applied is not particularly limited and may be in the range 1 to the total number of cycles possible in the time period of the alternating field application.

Each alternating field is preferably applied for a period of time of 1 to 20 minutes, preferably 5 to 20 minutes, more preferably from 10 to 20 minutes.

In a preferred embodiment, wherein the first alternating field is used to control movement of the analyte to the electrode, the first alternating field preferably has a frequency of 1 to 10⁹ Hz more preferably 10⁴ to 10⁷ Hz. This range of frequency may improve analyte movement by inducing dipolar charge on the analyte throughout the medium, particularly for DNA. There may be a decreasing effect on analyte movement when higher frequencies than 10⁷ Hz are used, as there is progressively less time for induced dipoles to form and for transport to occur.

The first alternating field, which may be pulsed, preferably has field strength of 10 kV/m to 1000 MV/m.

The first alternating field, which may be pulsed, preferably has a frequency of 30 Hz and a voltage of 350 mV.

The second alternating field, which may be pulsed, preferably has a frequency of 10² to 10⁹ Hz.

The second alternating field, which may be pulsed, preferably has a voltage of 10 mV to 5 V and even more preferably in the range from 10 mV to 2V.

In a preferred embodiment, wherein the second alternating field is composed of a plurality of pulses and is used to promote binding of the analyte to the binding phase, the second pulsed alternating field preferably has a pulse duration of 10⁻² s to 10⁻⁸ s. Preferably the second pulsed alternating field also has a pulse rise time of 10⁻⁸ s to 10⁻¹⁰ s. This pulse duration and pulse rise time may improve surface confined events, particularly for DNA hybridisation.

The first alternating field and second alternating field preferably have waveforms independently selected from sinusoidal, square, sawtooth and triangular.

Further alternating fields preferably have a frequency of 10² to 10⁹ Hz. Further preferred alternating fields preferably have a voltage range of 10 mV to 5 V. Further preferred alternating fields preferably have a pulse duration of 10⁻² s to 10⁻⁸ s. Further preferred alternating fields preferably have a pulse rise time of 10⁻⁸ s to 10¹⁰ s.

The analyte binding function of the present invention is made on the basis that the application of two alternating fields or the application of one or more pulsed alternating fields may be used to control specific events when processing a sample including transport of the target analyte from the bulk solution to the electrode and binding of the analyte to the electrode. Accordingly, the processing of the sample is quicker and more sensitive. The present invention is particularly useful for nucleic acid (e.g. DNA) assays because DNA is polarisable and, therefore, moves in an alternating field. However, the present invention may be employed for many different types of assays for different analytes well known to the person skilled in the art.

### Labelling the Analyte

In a preferred embodiment of the present invention the analyte is labelled with one or more labels to form the labelled analyte. In some aspects the device and method may operate without labelling the analytes, provided that the analytes contain some moiety that may act as a label (and in the context of the present invention, such moieties are considered to be labels) to allow distinction between different analytes.

The means for labelling the analyte are not particularly limited and many suitable methods are well known in the art. For example, when the analyte is DNA or RNA it may be labelled by enzymatic extension of label-bound primers, post-hybridization labelling at ligand or reactive sites or “sandwich” hybridization of unlabelled target and label-oligonucleotide conjugate probe (Fritzsche W, Taton T A, Nanotechnology 14 (2003) R63-R73 “Metal nanoparticles as labels for heterogeneous, chip-based DNA detection”).

Many different methods are known in the art for conjugating oligonucleotides to nanoparticles, for example thiol-modified and disulfide-modified oligonucleotides spontaneously bind to gold nanoparticles surfaces, di- and tri-sulphide modified conjugates, oligothiol-nanoparticle conjugates and oligonucleotide conjugates from Nanoprobes' phosphine-modified nanoparticles (see FIG. 2 of Fritzsche W, Taton T A, Nanotechnology 14 (2003) R63-R73 “Metal nanoparticles as labels for heterogeneous, chip-based DNA detection”).

Both DNA and RNA strands may be biotinylated. The biotinylated target strand may be hybridized to oligonucleotide probe-coated magnetic beads. Streptavidin-coated gold nanoparticles may then bind to the captured target strand (Wang J, Xu D, Kawde A, Poslky R, Analytical Chemistry (2001), 73, 5576-5581 “Metal Nanoparticle-Based Electrochemical Stripping Potentiometric Detection of DNA hybridization”). The magnetic beads allow magnetic removal of non-hybridized DNA.

### Label

The one or more labels are preferably selected from nanoparticles, single molecules and chemiluminescent enzymes. Suitable chemiluminescent enzymes include HRP and alkaline phosphatase.

Preferably, the labels are nanoparticles. Nanoparticles are particularly advantageous in the embodiment of the present invention where the label(s) used in step (a) are the same as the label(s) used in step (b) because they operate successfully in both optical and electrical detection methods. The proximity of the nanoparticles to the surface is not especially important, which makes the assay more flexible. In a preferred embodiment the nanoparticles comprise a collection of molecules because this gives rise to greater signal in optical and electrical detection methods than when single molecules are used.

Preferably the nanoparticles are selected from metals, metal nanoshells, metal binary compounds and quantum dots. Examples of preferred metals or other elements are gold, silver, copper, cadmium, selenium, palladium and platinum. Examples of preferred metal binary and other compounds include CdSe, ZnS, CdTe, CdS, PbS, PbSe, HgI, ZnTe, GaAs, HgS, CdAs, CdP, ZnP, AgS, InP, GaP, GaInP, and InGaN.

Metal nanoshells are sphere nanoparticles comprising a core nanoparticle surrounded by a thin metal shell. Examples of metal nanoshells are a core of gold sulphide or silica surrounded by a thin gold shell.

Quantum dots are semiconductor nanocrystals, which are highly light-absorbing, luminescent nanoparticles (West J, Halas N, Annual Review of Biomedical Engineering, 2003, 5: 285-292 “Engineered Nanomaterials for Biophotonics Applications: Improving Sensing, Imaging and Therapeutics”). Examples of quantum dots are CdSe, ZnS, CdTe, CdS, PbS, PbSe, HgI, ZnTe, GaAs, HgS, CdAs, CdP, ZnP, AgS, InP, GaP, GaInP, and InGaN nanocrystals.

The size of the labels is preferably less than 200 nm in diameter, more preferably less than 100 nm in diameter, still more preferably 2-50 nm in diameter, still more preferably 5-50 nm in diameter, still more preferably 10-30 nm in diameter, most preferably 15-25 nm.

The present invention is for detecting a plurality of analytes, each different analyte is labelled with one or more different labels relatable to the analyte. In this embodiment of the invention, the labels may be different due to their composition and/or type. For example, when the labels are nanoparticles the labels may be different metal nanoparticles. When the nanoparticles are metal nanoshells, the dimensions of the core and shell layers may be varied to produce different labels. Alternatively or in addition, the labels have different physical properties, for example size, shape and surface roughness. In one embodiment, the labels may have the same composition and/or type and different physical properties.

The different labels for the different analytes are preferably distinguishable from one another in the optical detection and the electrochemical detection. For example, the labels may have different frequencies of emission, different scattering signals and different oxidation potentials.

### Optical and Electrochemical Detection

The bound analyte may be detected at the electrode both optically and electrochemically. Furthermore the optical and electrochemical detection may either be simultaneous or sequential.

Further advantages of the device and method of the present invention are that they improve sensitivity and selectivity of the results. When a plurality of different analytes is to be detected, the device and method of the present invention increase the accuracy and number of the analytes detected. These advantages result directly from the use of both the optical data from the optical detection and the electrochemical data from the electrochemical detection to determine the identity and/or quantity of the analyte or plurality of analytes.

The sensitivity and selectivity of the device and method of the present invention are improved significantly compared to carrying out either an optical detection method or an electrical detection method.

The device and method of the present invention are also quick, cheap and simple to carry out.

With the device and method of the present invention it is typical that the detection data comprises information on the effect of the frequency of the oscillating voltage on the intensity, changes in the emission lifetime and/or the frequency of light emitted or absorbed by the one or more labels. Changes in emission and absorption frequency can result from variation in the chemical or environmental nature of the label, for example brought about by alterations in the degree of protonation (e.g. from changes in pH) or brought about by alterations in the degree of complexation (e.g. from changes in complexant proximity and/or concentration). Changes in emission lifetime can be observed as a consequence of variation in the environment surrounding the label (e.g. changes in solvation, local dielectric constant, and alteration in energy transfer to neighbouring species due to changes in separation). Such changes also lead to a change in the observed emission intensity (the observed emission intensity is governed by the emission lifetime and the number of emitting species).

The means for optical detection without being especially limited is configured to carry out optical emission detection, optical absorbance detection, optical scattering detection, spectral shift detection, surface plasmon resonance imaging, and surface-enhanced Raman scattering from adsorbed dyes.

In a preferred embodiment the means for optical detection is configured to carry out optical emission detection. Without being especially limited the optical emission detection can comprise the steps of irradiating the analytes with light capable of exciting the analytes and detecting the frequency and intensity of light emissions from the analytes. The optical data of frequency and/or intensity can be used to provide information on the identity and/or quantity of analytes present.

In the present invention, the light employed in the optical detection is not especially limited, provided that it is able to sufficiently excite the analytes. Typically the light to which the embedded analyte is exposed is a laser light. The frequency of the light is also not especially limited, and UV, visible or infrared light may be employed.

Other optical detection methods include optical absorbance detection, optical scattering detection, spectral shift detection, surface plasmon resonance imaging, and surface-enhanced Raman scattering from adsorbed dyes are well known in the art (Fritzsche W, Taton T A, Nanotechnology 14 (2003) R63-R73 “Metal nanoparticles as labels for heterogeneous, chip-based DNA detection”).

In a preferred embodiment, the means for electrochemical detection is configured to carry out by electrochemical impedance spectroscopy.

The identity and/or quantity of the analyte or plurality of analytes are determined from both the optical and electrochemical data obtained.

For example, when optical emission detection is used as the optical detection method the intensity of light emissions can be used to provide information on the identity and/or quantity of analytes present.

For example, with the electrochemical detection the amount of analyte present can be quantified by voltammetry. Quantitative data can be obtained from the signal peaks by integration, i.e., determining the area under the graph for each signal peak produced.

In accordance with the present invention the device can be configured to carry out optical and electrochemical detection simultaneously or sequentially.

### Simultaneous Detection

In this invention, optical and electrochemical measurements can be made simultaneously. An implementation of this embodiment of the present invention is as follows. An oscillating sinusoidal voltage is applied across a solution containing charged species. The species will behave differently depending upon the frequency of the oscillation, the composition of the solution and the surrounding conditions (temperature, pressure etc.). This is because they will affect the mobility of the species in the solution. High frequency and/or low mobility give rise to simple oscillation of the species which in fact looks like simple capacitance. Low frequency and/or high mobility allows the species to reach the electrodes and undergo redox reaction at the surface, causing a current to flow, which can be measured.

This involves varying the frequency, and measuring the changes in current. Because these changes depend on the identity (mobility) of the species in the solution, they provide information on the species and processes occurring in solution. Clearly, a binding event greatly affects mobility and the device and method could be usefully employed to detect binding in biological species. Typically the frequency is progressively lowered and a transition from simple oscillation to input/output of charged species is measured. However, these measurements are known in the art when carried out on their own.

As has been said, in the present invention, this can be combined with an optical measurement. In a system such as the one above, the frequency of light emission is typically constant, but the intensity may change with the frequency of the applied electrochemical perturbation. This is because the reagents may be able to penetrate farther and cause more reaction at lower frequencies. The intensity and/or frequency of the emitted light can be measured, and the effect of the frequency of oscillation of the voltage on the intensity and/or frequency of the emitted light can also be measured. As has been said, typically it is the intensity of the emitted light that changes with the frequency of the current, and it is this change in intensity that is measured. However, it may be the frequency of the emitted light that changes, or both frequency and intensity, depending on the nature of the system and species under investigation. The relationship generally depends on the speed of the differently charged molecules and/or ions in the solution.

To re-iterate, in a typical system of the present invention, a particular analyte having a single redox state is investigated by applying an oscillating voltage and measuring the intensity and/or frequency of emitted light from the species. However, other variations to this system are possible in the present invention.

Some fluorescent labels which can be used as tags in biosystems are also redox active, being able to switch between fluorescent and less or non-fluorescent states. Those that do not can also have their fluorescence output reduced or eliminated by quenching species. Modulation of the voltage on an underlying electrode surface onto (or adjacent electrode surface near) which labelled species (such as oligonucleotides) have been immobilised by standard immobilisation procedures will produce a modulation in fluorescence output from the label (either through direct redox reaction or via reaction with a soluble redox mediator or quencher). This change in light output is typically measured through use of a suitable detector e.g. a photovoltaic or photomultiplier, which can measure the light intensity of the emitted light. Both the light response and current response can be measured by analysing the ratio of photovoltaic voltage to applied voltage (this may be termed fluorescence impedance) as a function of frequency (fluorescence impedance spectroscopy) and the ratio of current to applied voltage as a function of frequency. The extent of light and current output modulation (both in-phase and out-of-phase) as a function of the frequency of the applied voltage will be determined by such factors as the rate of diffusion and/or migration of the mediator or quencher through the immobilised oligos, the rate of reaction (which may be affected by the availability of the label for reaction) and the distance of the label from the electrode surface. Any or all of these factors may change significantly upon specific oligonucleotide hybridisation, as indeed they may with non-specific binding. However, the combination of all of these measurements (light modulation, current modulation and frequency) may lead to a characteristic and distinct change in the measured light impedance and impedance spectral data either alone or in combination indicative of specific binding and distinct from non-specific binding.

### Sequential Detection

The present inventors have discovered that the device can be configured to carry out optical and electrical detection sequentially. Without being especially limited as to the order of detection the device can be configured to carry out the optical detection first followed by the electrochemical detection.

The inventors have also surprisingly discovered that after optical detection the labelled analytes are in a state that can be successfully used in electrochemical detection.

The advantages of the present invention are that they improve sensitivity and selectivity of the results. When a plurality of different analytes is to be detected, the present method increases the accuracy and number of the analytes detected. These advantages result directly from the use of both the optical data from the optical detection and the electrochemical data from the electrochemical detection to determine the identity and/or quantity of the analyte or plurality of analytes.

In a preferred embodiment of the invention, the one or more labels that are suitable for optical and electrochemical detection which are used are the same. This more readily allows the data from both the optical and electrical methods to be used to determine the identity and/or quantity of analyte or plurality of analytes in one sample.

In an alternative embodiment of the invention, the labels used for optical detection are different to those used in electrochemical detection. This is advantageous because it provides more data when the optical detection and electrochemical detection are carried out on separate labels.

### DESCRIPTION OF THE FIGURES

The present invention will now be described in further detail by way of example only, with reference to the following drawings, in which:

FIG. 1 shows the effect of an oscillating sinusoidal voltage applied across a solution containing charged species.

FIG. 2 shows biotin integrated into a DNA or RNA molecule. When binding with a complementary probe occurs the duplex is labelled with an anti-biotin antibody which is tagged with a nanoparticle suitable for optical and electrical detection.

FIG. 3 shows an electrode configuration in accordance with the present invention which can perform (1) electrochemical detection (e.g. electrochemical impedance spectroscopy), (2) optical detection (e.g. total internal reflection fluorescence), and (3) forced transport of target molecules (e.g. by dielectrophoresis) at the same time or sequentially.

FIG. 4 shows a complete mask layout of the gold interdigitated microelectrode structures, including four device chips, alignment marks and dummy metal lines to speed lift-off processing. The number of digits (N) on each electrode is preferably from 5 to 10. The length of each digit (L) is preferably from 75 to 150 nm. The width of each digit (W) and the width of the gap between each digit (G) is each preferably from 1.5 to 10 μm and W and G are preferably the same.

FIG. 5 shows Nyquist plots of a gold interdigitated electrode used for dielectrophoresis (DEP) measurements.

FIG. 6 shows a gold electrode (IDE) in a solution of polystyrene beads. The IDE was connected to an AC field of 7 V at 50 MHz.

FIG. 7 shows a gold IDE electrode in a solution of polystyrene beads. Images were recorded with different applied voltages at a frequency of 100 kHz. (a) 2V, (b) 4V, (c) 6V & (d) 8V.

FIG. 8 shows a gold IDE electrode in a solution of polystyrene beads. Images were recorded with an applied voltage of 8 V at a frequency of 100 kV at different time interval. (a) Field OFF reference time, (b) Field ON (15″), (c) Field ON (45″) & (d) Field ON (2′).

FIG. 9 shows a gold IDE electrode in a solution of polystyrene beads. Images were recorded with an applied voltage of 5 V at a frequency of 20 kV at different time interval. (a) Field OFF reference time, (b) Field ON (15″), (c) Field ON (45″) & (d) Field ON (2′).

FIG. 10 shows a gold IDE electrode in a solution of polystyrene beads. Images were recorded with an applied voltage of 8V at a frequency of 20 kV at different time interval. (a) Field OFF reference time, (b) Field ON (12″), (c) Field ON (15″), (d) Field ON (1′5″), (e) Field ON (2′), (f) Field ON (10′) & (g) Field ON (30′).

FIG. 11 shows a gold IDE electrode in a solution of 1 nM Qdots in distilled water. (a) Field off, (b) The IDE was connected to an AC field of 2V at 1 MHz for 6 min, (c) same as (b) with reverse polarisation (d) the electrode was measured after being left 12 hours in distilled water without field.

FIG. 12 shows three Gold IDE electrodes in a solution 1 nM Qdots in distilled water. Each electrode was connected for a duration of 6 min to an AC field of 2V at 20 KHz (a), 100 kHz (b) and 1 MHz (c).

FIG. 13 shows Transmission image of a damaged IDE. The image was recorded after applying an AC field of 5 V at 20 kHz.

FIG. 14 shows a gold IDE electrode immobilised with complementary probe, in a solution 1 nM Qdots in 3 mM HEPES buffer, pH 6.9. (a) Field off, (b) The IDE was connected to an AC field of 2 V at 100 kHz for 6 min, (c) The IDE was connected to an AC field of 2.5 V at 100 kHz for an extra 6 min.

FIG. 15 shows two Gold IDE electrodes immobilised with complementary probe connected to an AC field of 2.5 V at 100 kHz for 10 min. The electrodes were immersed in 3 mM HEPES buffer solution containing (a) 1 nM Qdots and 1 nM target, (b) 1 nM Qdots and 10 nM target (c) Shows (b) after washing in SSC+SDS solution.

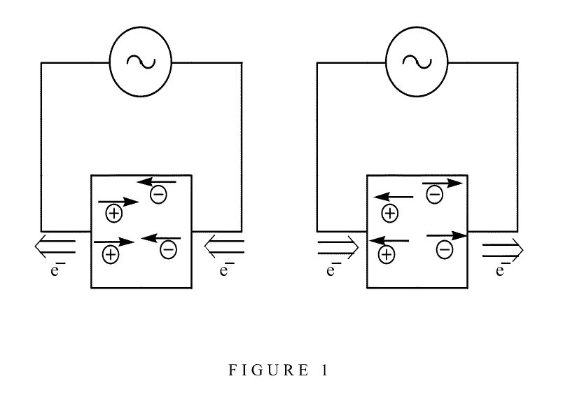

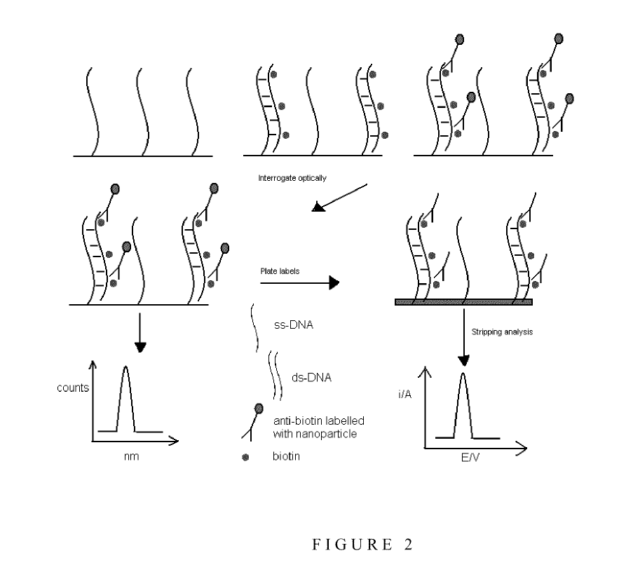

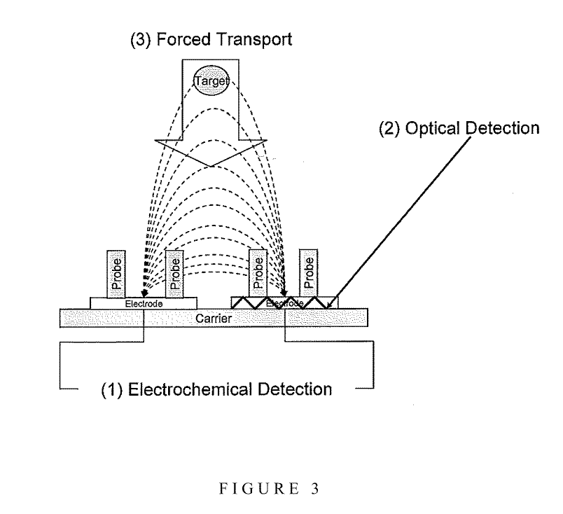

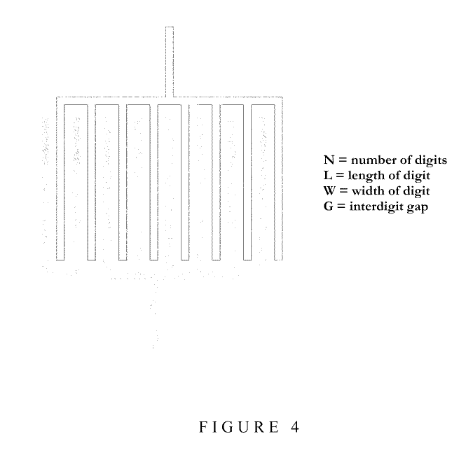

The present invention will be described further by way of example only with reference to the following specific embodiments.

### EXAMPLES

### Example 1

### Labelling DNA Analyte with Nanoparticle

RNA is reverse transcribed, incorporating a nucleotide labelled with a nanoparticle, according to conventional techniques.

### Example 2

### Optical and Electrochemical Detection

Labels are excited with light of a given wavelength, and their emission is detected at a predetermined wavelength, according to conventional methods.

Electrochemical detection is then carried out on the labelled analyte from the optical detection method. The labelled analyte is dissolved in an acidic solution. Electrodes are inserted into the solution and a deposition potential of −0.8 V is applied. After a deposition time of two minutes a second potential of +1.2 V is applied to oxidise the deposited nanoparticles. Electrochemical currents are recorded and integrated to give the charge passed in each process, which determines the amount of deposited nanoparticles.

In the following Example, the effect on hybridization efficiency of applying the AC fields used in the invention was investigated by electrochemical impedance spectroscopy (EIS) and fluorescence detection.

### Example 3

### Effect on Hybridization Efficiency of Applying the AC Fields Investigated by Electrochemical Impedance Spectroscopy (EIS) and Fluorescence Detection

### Protocols

Two samples were investigated: Fluorescently labelled 1 μm polystyrene beads and Qdot 605-streptavidin-conjugates. The 1 μm diameter polystyrene beads were obtained from Invitrogen. 100 μL of the 2% bead solution was diluted with 4.9 ml of distilled water. A 1 nM solution of Qdot was also prepared in distilled water.

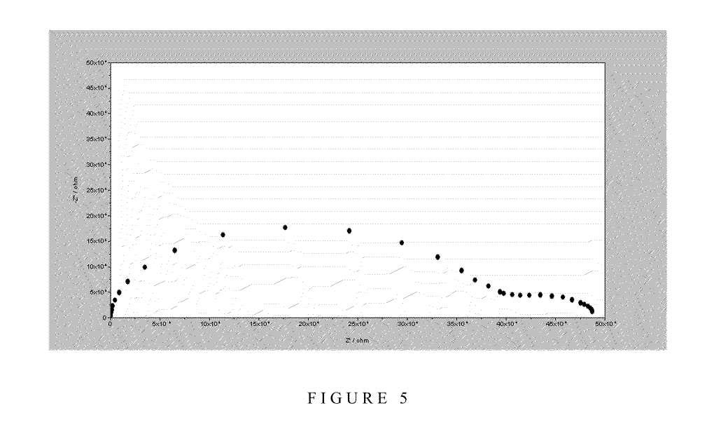

Prior to the experiment, an electrode control was performed by measuring the impedance of the interdigitated electrodes (IDE). This was done in a solution of 10 mM [Fe(CN)6]3-/4- by applying a 10 mV rms amplitude voltage at frequencies between 1 MHz and 0.1 Hz to the electrode with a potentiostat. The characteristic semi-circle observed (FIG. 5) confirmed that both IDE electrodes and connections were properly working.

After emptying the flow cell and thoroughly cleaning the electrodes with distilled water, the solution of polystyrene beads was injected into the flow cell and the potentiostat replaced by a 50 MHz Pulse Generator (HP 8112A). The sample was excited with a 470 nm pulsed laser diode and the fluorescence collected through a 10× objective and sent onto a cooled EMCCD camera (−70° C.) via a 535 nm 40 nm bandpass filter.

### Dielectrophoresis (DEP) of Microspheres

The effect of the magnitude of applied AC voltage (and hence field) and frequency applied to the IDEs was studied experimentally on observed DEP over a frequency range spanning from 50 MHz to 20 kHz and an applied peak voltage up to 8 V.

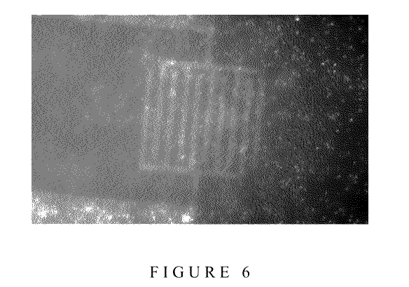

At the highest frequencies, it was observed that the beads were homogeneously distributed within the field of view, even when a relatively high voltage was applied. This is clearly observed (FIG. 6) for 7 V at 50 MHz.

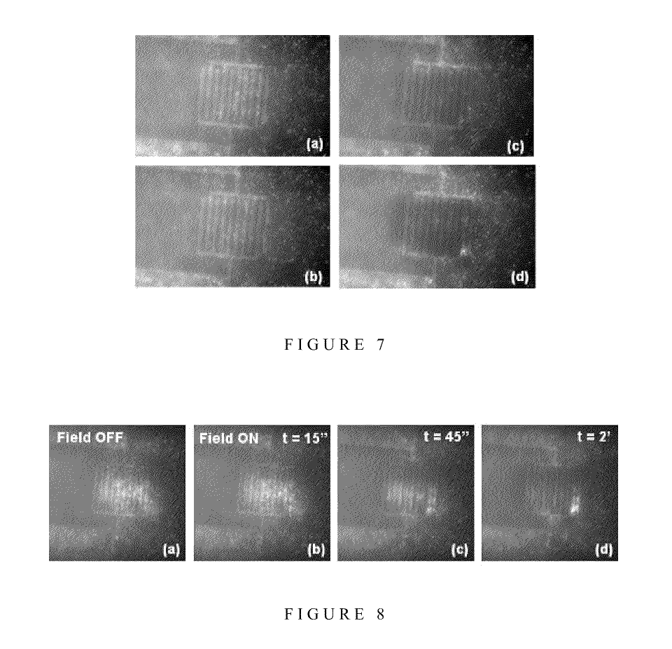

On lowering the frequency to 100 kHz, it became possible to observe a reorganisation of the beads. FIG. 7 shows a series of images corresponding to different applied voltages. At 6 V (figure (c)) one can observe that the vertical part of the top electrode becomes brighter. At 8 V a dark area starts to appear showing the field geometry across the IDE. The concentration of beads at the IDE becomes apparent within the first minute as shown (FIG. 8) although the response is still relatively weak at this frequency.

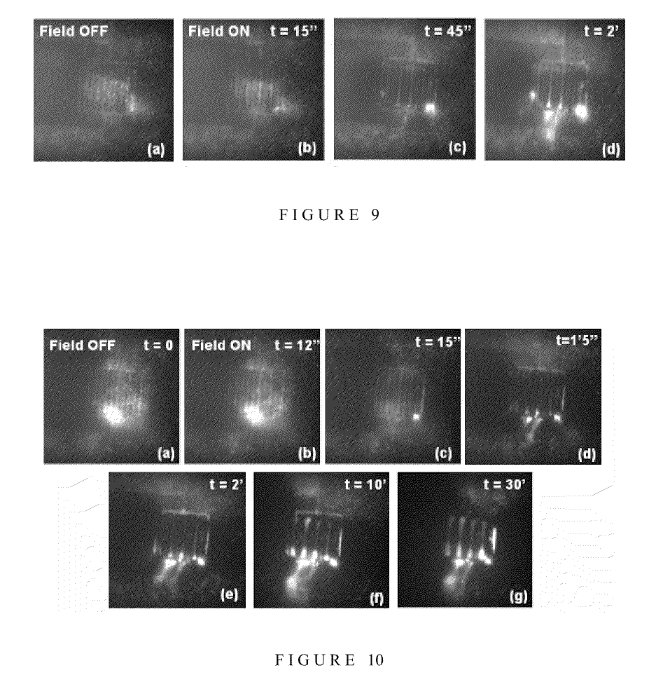

When lowering the frequency down to 20 kHz at an applied peak voltage of 5 V, the signal becomes significantly brighter as shown (FIG. 9). FIG. 10 shows a series of images recorded with an applied voltage of 8 V. As the spacing between electrodes is 10 μm, the root mean squared (rms) field across the electrode is approximately 5.7×105 V m⁻¹ and even higher at the tip of the electrode due to local enhancement. The time series presented FIG. 10 shows clearly that the beads start first to condensate on the tip fingers (top electrode) and gradually cover the length of the electrode fingers.

DEP of Quantum Dots and Quantum Dots with Bound Target DNA

A series of experiments was carried out to investigate the trapping of Qdots on gold IDEs. The trapping of relatively small DNA fragments (less than 10 kbp) requires extremely high field strengths, of the order of 107 V rms m⁻¹. However the response of the relatively large Qdots should be much greater. Here the approach was to use Qdot labels as a DEP vector to trap target DNA bound to Qdots via streptavidin-biotin interaction at the electrode, therefore achieving localised DNA concentration using lower field strengths. Three DEP experiments were conducted using the following solutions: Qdot in distilled water, Qdot in HEPES buffer (required for hybridization), and finally Qdot labelled target in HEPES buffer.

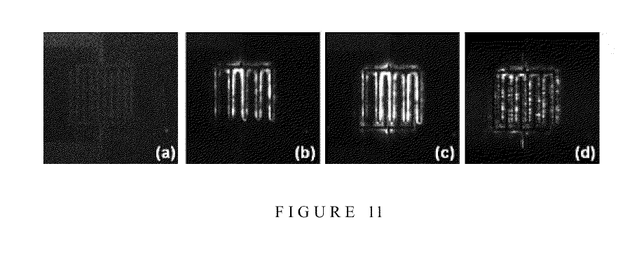

FIG. 11 shows an electrode immersed in 1 nM of Qdots dissolved in distilled water. When an AC field is applied (here 1 MHz, 2 V peak voltage) for several minutes, the Qdot can be seen to concentrate at the periphery of the electrode fingers, clearly revealing the shape of the attractive electrode (b) in the IDE pair. When the polarity was reversed, the opposite electrode become attractive as expected and as shown in FIG. 11(c). It was also observed that once the Qdots have been concentrated at the electrode, the latter tend to stay there as shown in FIG. 11(d), where the electrode is displaying a strong signal even after 12 h in distilled water. This is consistent with high concentration Qdot coagulation and electrode adsorption.

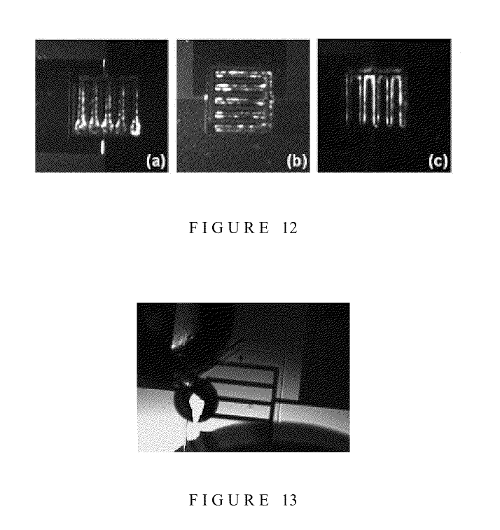

This experiment was then repeated over a range of frequencies. FIG. 12 shows the result obtained with an applied AC field of 2 V at 20 kHz, 100 kHz and 1 MHz. At the lowest frequency (a) the Qdots are mostly attracted to the tip of the electrode fingers where the field strength is the highest. At higher frequencies ((b)&(c)), the attraction of the nanoparticles was observed to be more homogeneous. Typically, best results were obtained at 100 kHz with an applied peak voltage between 2 and 3 volts (of the order of 2×105 V rms m⁻¹). At higher voltages, the formation of bubbles and ultimately damage to the electrode was observed, as shown in FIG. 13. (The picture shows that only one electrode is present, the other one has completely detached.)

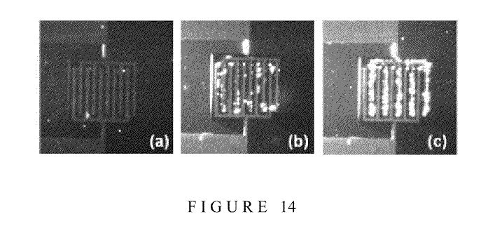

Hybridization is usually conducted in a buffer solution such as SSC. However, such a solution has been shown to lead to less favourable results than when used in combination with these DEP experiments. To circumvent this effect the DEP of Qdots was investigated in an alternative hybridization buffer, HEPES (3 mM, with 1 mM NaOH, pH 6.9), which has a conductivity of approximately 20 μS cm⁻¹. The results presented (FIG. 14) show the successful build up of Qdots at the attractive electrode through DEP after 6 and 12 mins.

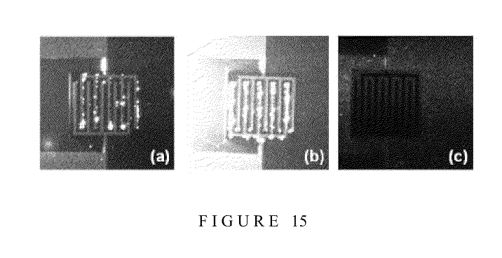

Finally, the DEP of Qdot-labelled target DNA is shown (FIG. 15) for 1 nM and 10 nM target concentration. Figures (a) and (b) demonstrate that this labelled DNA can be efficiently concentrated at the electrodes via DEP of the Qdot label. It is interesting that, unlike Qdots, the Qdot labelled DNA does not appear to be irreversibly adsorbed at the electrode surface (FIG. 15(c)).

### CONCLUSIONS

The results presented above show that positive DEP can be used to attract and concentrate both polystyrene beads and nanocrystal Qdots at the electrode surface. As beads and Qdots can be functionalised to bind to DNA as labels, DEP of these species can be used to concentrate a specific labelled target at the electrode on the timescale required for near patient environment detection in hybridisation compatible solutions. This opens up the possibility of using Qdot labelling of DNA for fluorescence detection and DEP transport, with its potential to speed up hybridization process.

In more detail, application of an AC field during hybridization of target DNA on probe-modified, interdigitated gold microelectrodes yielded a substantially enhanced hybridization efficiency, which could be clearly discriminated from unspecific binding of non-complementary DNA.

The response after AC field application was one order of magnitude higher, as compared with hybridization without the AC field. An increase in the electron transfer resistance up to 5 min AC field application in the absence of target DNA was also observed. This might be explained with a re-orientation of the surface bound probe layer making it more accessible to the target molecules.

In summary, and without being bound by theory, the enhanced hybridization efficiency during AC field application might be caused by the re-orientation of the probe layer or the increase of the local target concentration by AC field-induced dielectrophoretic trapping of target oligonucleotides or by a combination of both of these phenomena.

In order to further investigate possibilities to concentrate analytes on the site of interdigitated electrodes, the effect of a wide range of frequencies and voltage amplitudes on the dielectrophoretic trapping of 1 μm size fluorescent microspheres and on streptavidin/quantum dot-conjugates in the set-up for combined detection was tested, and analysed it by TIRF. These experiments demonstrated the concentration of beads and Qdots on the surface of interdigitated electrodes applying AC fields of 20 kHz with an amplitude of 5 to 8 V. The possibility to concentrate Qdot-streptavidin-conjugates on the site of surface immobilized probes implicates the possibility to concentrate any kind of target via biotinylated detection probes or biotinylated secondary antibody.

1. A device for assaying one or more analytes, said device comprising:
(a) a plurality of electrodes;
(b) a means for optical detection; and
(c) a means for electrochemical detection;
wherein the device is configured such that the electrode is capable of promoting transport of an analyte when a field is applied to the analyte via the electrode; and wherein the means for electrochemical detection employs the electrode; and the means for optical detection employs the electrode and wherein the device is configured to carry out dielectrophoresis; and wherein the plurality of electrodes is in the form of an interdigitated electrode structure.

2. The device of claim 1, wherein the electrode is composed of an optically transparent material.

3. The device of claim 2, wherein the optically transparent material is ITO.

4. A device according to claim 1, wherein the device is suitable for attaching an analyte to the electrode, detecting the optical properties of the analyte and detecting the electrochemical properties of the analyte.

5. A device according to claim 4 wherein the optical detection and electrochemical detection can either be simultaneous or sequential.

6. A device according to claim 1, wherein the electrode further comprises a capture probe, which capture probe is capable of reacting with the analyte to capture the analyte on the electrode.

7. A device according to claim 1, wherein the device is suitable for detecting the presence or absence of an analyte in a sample, purifying the analyte in the sample, isolating the analyte in the sample or sorting the analyte in the sample.

8. A device according to claim 1, wherein the device is suitable for detecting the presence of the analyte in a sample and optionally quantifying the analyte.

9. A device according to claim 1, wherein the device is configured to apply at least two alternating fields, wherein at least one alternating field is composed of a plurality of pulses to influence a sample and/or the electrode or capture probe capable of binding an analyte.

10. A device according to claim 9, wherein the at least two alternating fields are applied simultaneously or sequentially.

11. A device according to claim 9, wherein each alternating field has a combination of frequency, pulse duration and pulse rise time that is unique in relation to that combination for all other alternating fields.

12. A device according to claim 9, wherein the first alternating field has a frequency of 1 to 109 Hz.

13. A device according to claim 9, wherein the first alternating field has a field strength of 10 kV/m to 100 MV/m.

14. A device according to claim 9, wherein the second alternating field is capable of promoting binding of the analyte to the binding phase.

15. A device according to claim 9, wherein the second alternating field has a pulse duration of 10⁻² s to 10⁻⁸ s.

16. A device according to claim 9, wherein the second alternating field has a pulse rise time of 10⁻⁸ s to 10⁻¹⁹ s.

17. A device according to claim 9, wherein the second alternating field has a frequency of 10² to 10⁹ Hz.

18. A device according to claim 9, wherein the second alternating field has a voltage of 10 mV to 5 V.

19. A device according to claim 9, wherein the first alternating field and second alternating field have waveforms independently selected from sinusoidal, square, sawtooth and triangular.

20. A device according to claim 1, wherein the analyte comprises one or more compounds selected from a cell, a protein, a polypeptide, a peptide, a peptide fragment, an amino acid, polynucleotides such as DNA or RNA, oligonucleotides, nucleotides, natural and synthetic chemicals and metabolites.

21. A device according claim 1 wherein the analyte is labelled with one or more labels relatable to the analyte which are suitable for optical detection.

22. A device according to claim 21, wherein the labels are selected from nanoparticles, single molecules, chemiluminescent enzymes and fluorophores.

23. A device according to claim 22, wherein the labels are nanoparticles comprising a collection of molecules and/or atoms.

24. A device according to claim 22, wherein the nanoparticles are selected from metals, metal nanoshells, metal binary compounds and quantum dots.

25. A device according to claim 22, wherein the nanoparticles are metal compounds selected from CdSe, ZnS, CdTe, CdS, PbS, PbSe, HgI, ZnTe, GaAs, HgS, CdAs, CdP, ZnP, AgS, InP, GaP, GaInP, and InGaN.

26. A device according to claim 22, wherein the nanoparticles are selected from gold, silver, copper, cadmium, selenium, palladium and platinum.

27. A device according to claim 22, wherein the nanoparticles are less than 100 nm in diameter.

28. A device according to claim 27, wherein the nanoparticles are 5-50 nm in diameter.

29. A device according to claim 28, wherein the nanoparticles are 10-30 nm in diameter.

30. A device according to claim 21, wherein the one or more labels for each different analyte have different physical properties.

31. A device according to claim 30, wherein the physical properties are selected from one or more of size, shape and surface roughness.

32. A device according to claim 21, wherein the labels for each different analyte have different compositions.

33. A device according to claim 21, wherein the labels for each different analyte are of different types.

34. A device according to claim 1, wherein the means for optical detection is configured to carry out any of optical emission detection, optical absorbance detection, optical scattering detection, spectral shift detection, surface plasmon resonance imaging, total internal reflection fluorescence and surface-enhanced Raman scattering from adsorbed dyes.

35. A device according to claim 34 wherein when the means for optical detection is configured to carry out optical emission detection the device is further configured to irradiate the labelled analytes with light capable of exciting the labels and detecting the frequency and/or intensity of light emissions from the labels.

36. A device according to claim 35, wherein the light is laser light.

37. A device according to claim 35, wherein the light is selected from infra-red light, visible light and UV light.

38. A device according to claim 37, wherein the light is white light.

39. A device according to claim 1, wherein the means for electrochemical detection is configured to carry out electrochemical impedance spectroscopy.

40-43. (canceled)

44. A method for assaying one or more analytes, which method comprises the steps of:
a) promoting transport of an analyte
b) performing an optical measurement of the analyte
c) performing an electrochemical measurement of the analyte;
wherein said method employs the device of claim 1.

45. The method of claim 44 wherein the steps of performing an optical measurement of the analyte and performing an electrochemical measurement of the analyte are carried out either simultaneously or sequentially.
